(19) United States
(12) Patent Application Publication
(10) Pub. No.: US 2019/0315037 A1
(43) Pub. Date: Oct. 17, 2019

(54) METHOD FOR INDIRECTLY DERIVING A SYSTEMATIC DEPENDENCY BETWEEN A SETTING PARAMETER AND AN OPTICAL PROPERTY OF A FILM WEB, METHOD FOR ADAPTING THE QUALITY OF A FILM WEB

(71) Applicant: Reifenhäuser GmbH & Co. KG Maschinenfabrik, Troisdorf (DE)

(72) Inventors: Holger Schumacher, Augustin (DE); Christoph Lettowsky, Aachen (DE); Jürgen Rehkopf, Singapore (SG); Paul Walach, Troisdorf (DE)

(21) Appl. No.: 16/343,143

(22) PCT Filed: Aug. 3, 2017
(86) PCT No.: PCT/DE2017/000244

§ 371 Date: Apr. 18, 2019

(30) Foreign Application Priority Data
Oct. 18, 2016 (DE) 10 2016 012 431.8
Jul. 19, 2017 (DE) 10 2017 007 140.3

(51) Int. Cl. B29C 48/92; B29C 48/08; B29C 48/25; B29C 48/49; B29C 48/10

(52) U.S. Cl. CPC B29C 48/92; B29C 48/08; B29C 48/251; B29C 2948/92361; B29C 48/10; B29C 2948/92857; B29C 48/49

(57) ABSTRACT

The invention relates to the determination of the optical quality of a film. On the one hand, a correlation of the obtained measured values with the production parameters, which are detected in a time-synchronous manner at the extrusion plant, is carried out. On the other hand, a correlation of said obtained measurement data with the geometric and/or functional properties of a film, for example the water vapor permeability, is carried out. The obtained correlation of data is used in the process for controlling the running production process of the film to an optimum operating point. Consequently, the resulting functional properties of a film are improved in an automated manner and met according to the desired specifications. The operator can predetermine which geometric and/or functional properties of a film are accepted as a control variable.

The invention relates to a method for indirectly deriving a systematic dependence between a setting variable and an optical property of a film web, a method for adjusting the quality of a film web, a method for producing a film web and a device for producing a film web.

In particular, the invention relates to a method for indirectly deriving a systematic dependence in a blown film or cast film production process of a film web between a setting variable of the production process and an optical property of the produced film web, a process for producing a film web, wherein a blown film or cast film plant is operated, wherein during the manufacturing process one of the aforementioned methods is carried out, and a device for producing a film web, the device comprising an extruder for plasticizing a thermoplastic, a nozzle for outputting the plastic, a deflection part and a winder, wherein the device comprises an actuator for inline affecting/influencing the quality of the film and a data processing and evaluation unit, wherein the data processing and evaluation unit has a programming, wherein the programming is performed for performing one of the above mentioned methods.

In the production of a film of thermoplastic material is formed out one of the extruder provided plastic melt using a wide slot nozzle or an annular slot nozzle to a film web or into a film tube. The film tube is then guided by the calibration basket and fold up in the flattening part. After the most reversing moving away part, the film passes over the roller conveyor to the winder and is wound there on provided cores.

Due to the process, a film has differences in its functional properties, if the process was operated at different operating points. For example, here, the breathability of a film can be mentioned, which can be influenced by different stretch setting or a modified recipe.

The manifold possibilities of the operator, to take influence on these functional characteristics exceeds in their complexity—due to the superimposition of the effects—the comprehensions of the plant operator, increasingly. These functional properties can not yet be determined inline on a film.

However, on films, the optical properties can be determined inline. For example, a print image, a degree of gloss or haze is determined. The detecting of these optical properties is possible today with many sensors. These are mostly camera systems with defined illumination, which translate the optical properties of the film into measured values.

Basically, optical inspection systems are known in film production. These have hitherto served purely to detect the optical film qualities with respect to specks, scratches, inclusions, haze, gloss, etc.

The inspection and measuring systems used to detect the optical quality in flat and blown film extrusion have hitherto only served to detect the optical quality of the film.

A conclusion on the resulting functional properties of the film or the manufacturing conditions can not be made yet.

Thus, functional properties of the film can be set only to a certain target value, if the operator has a lot of experience. In addition the process occurs often iterative.

A correlation of the detected optical measuring values with the functional properties is not yet performed. In this way, the potential to increases the quality of the film by changing the manufacturing parameters to the ideal setting, is not used.

The DE 31 07 701 C2 describes a method for controlling the thickness of extruded flat films or plates of thermoplastic materials.

The DE 40 33 974 C2 discloses a process for the production of surface and in cross-section annular extrudates made of plastic.

The DE 41 18 122 A1 describes a method for determining and/or regulating the orientation degree of blown film produced in blown film plants.

DE 42 35 163 A1 discloses a device for extruding plastic profiles, in particular of tubular profiles with an extruder.

The WO 2007/107147 discloses a method for detecting the flatness deviation of flexible, web-like flat goods.

The DE 10 2013 100 866 A1 describes a method for the indirect determination of a specific recipe in an extrusion process in an extrusion device and a corresponding extrusion device for producing an extrusion product.

DE 10 2015 006 891 A1 of the same applicant discloses a plant for producing a film web and a method for operating such a plant.

The invention is based on the object, to provide to the prior art an improvement or an alternative.

According to a first aspect of the invention, the object is solved by a method for indirectly deriving a systematic dependence in a blown film or cast film manufacturing process of a film web between a setting value of the manufacturing process and an optical property of the film web produced, wherein an optical property of the film web is determined as a first parameter of the method by means of a sensor inline on produced the film web, a second parameter of the process is determined, in particular a parameter of the production device from the production of the film web, in particular, the setting value the production process is determined, wherein a data detection system digitizes and records, as needed, the specific parameters related to each other in a database, and derives systematically from the data stored in the database systematically the specific dependence between the parameters.

Conceptually, the following is explained:

First of all, it should be noted that within the scope of the present patent application indefinite articles and numbers such as “one”, “two” etc. in the normal case should be understood as “at least” information, so as “at least a . . . ”, “at least two . . . ”, etc., unless expressly stated in the respective context or in case that for the skilled person in the art it is obvious or technically compelling, that there can only be meant “exactly one . . . ”, “exactly two . . . ” and so on.

A “dependency”, in particular a “systematic dependency” and/or a “specific dependence”, describes the relationship of the dependence of a thing of another. It can be obtained by varying one thing under observation of another. A mathematically functional dependence is in this context not required here, but possible.

A “film web” may be either a single-ply film web, or a tubular film web, wherein the hose pipe is separated or can be left tubular. Furthermore, a folded hose pipe may also be referred to as a film web. The film web may be single-layered or multi-layered.

A “setting variable set value” is the specification value/setpoint for an actuator to set a “setting variable”. The actual value of the set value is a “setting variable actual value”.

An “optical property” here is synonymous with an “optically detectable property”, i.e. a property which, can be detected and evaluated with the help of an optical process. Examples of optically quantifiable properties of film webs are the gloss, the haze, the transparency or the specks in the film web. In particular, it is here pointed out that the optically detectable properties also contain subsets of geometric or functional properties. As an example a geometric, optically detectable property is mentioned, for example, the thickness profile of the film web.

The “quality” of the film web comprises all objectively and subjectively perceptible properties of the film web. In this context, it is differentiated in particular between optical, geometrical and functional properties.

A “geometric property” includes all quantifiable properties of the geometry of the film web by a touching or touching free measurement method. As examples are mentioned the thickness profile of the film web, the width of the film web, the flatness position of the film web, the single layer thickness of the film web or the surface roughness of film web, in particular the melt fracture and the orange peel of the film web.

A “functional property” means that properties of a film which qualitatively or quantitatively can be assigned to a function of the film. As an example, it could be thought, about the breathability or the barrier effect of the film web.

A “sensor” or “detector” is a technical component that specifically can be detect physical or chemical characteristics and/or the material nature of its surroundings qualitatively or as measured variable. These values are detected by means of physical or chemical effects and are transformed into an analog or digital electrical signal.

For detecting the optical quality, a measuring device and/or a measuring system is used.

A “measurement system” is a system for the detection of a “measured variable”. The output value of the measuring system is a measured value.

A “measured value” is the instantaneous value of a “measured variable”. A “measured variable set value” is the required value for a measured variable.

A “setting value measuring system” determines numerically the value of a setting value.

A “property measurement system” determines numerically the value of a property.

A “measurement system” determines numerically the value of a measured variable.

A “measuring device” means a measuring system for detecting an optical property, which consists of a light source and a detector, wherein the light source emits a light beam onto a film web and a reflected and/or transmitted light beam is detected by a detector, wherein the light detected by the detector is used for determining and evaluating the film topography. The measuring device can be used for single-layer or multi-layer film webs with one or more layers. Furthermore, a measuring device can have an additional adaptive lighting of the background. The measuring device can illuminate the object, in particular the film web, by light-through method and or in on top light method and/or by streaks method. The object may be illuminate against a light background and/or against a dark background. At dark backgrounds it is differentiated between a dark background, a near background and a distant dark background. In particular, the measuring device uses a triangulation and/or a reflection method and/or a transmission method.

A “triangulation method” is a geometric method for optical distance measurement by accurate angle measurement within triangles. Surfaces can therefore be measured with a triangulation method by determining the positions of individual points. In the case of a film web, light is projected to the film and by means of triangulation of the reflected light, the position of individual surface is determinate, whereby the film topography is determined and evaluated. Based on the film topography, other properties of the film web can be deduced.

A “reflection method” uses the properties of the reflection of waves at an interface at which the wave impedance or refractive index of the propagation medium changes, to evaluate the properties of a medium. Normally, during reflexion only a part of the energy of the incident wave is reflected. In the case of a film web light is projected onto the film and the reflection is observed at a matrix camera. The observed reflection image is used to determine and evaluate the optical properties of the film web.

A “transmission method” is a method in which the permeability of a medium for waves is evaluated by the degree of transmittance. Meets a wave on a different medium of finite thickness, it is reflected partially depending on the material properties of the medium at the interfaces and is completely or partially absorbed when traversing. The remainder is transmitted due to the different medium and exits again on the opposite side of the different medium. The optical properties are determined and evaluated via the reflected light, which is detected with a matrix camera.

Based on the “transmittance” (German: Transmissionsgrad) as the quotient of the wave intensity behind and before the deviating medium, properties of the deviating medium can be determined, in particular the optical properties of the film web.

A “light source” means any light source, i.e. a light source with any frequency and intensity of the wavelength distribution. Thus, the light source can emit visible, but also invisible light to humans. In particular, it means light source as laser light, white light, LED light or infrared light.

Furthermore, a light source also means a combined source for different ones light types of any combination.

A “data detection system” is used to record physical variables. Depending on the sensor used it has an analog-to-digital converter and a measured value memory or data memory. The data detection system can capture several measured values in parallel.

A “database” is an electronic data management system database. The object of the database is to store large amounts of data efficiently, consistent and durable, and to provide needed subsets of the stored data in different, needs-based forms of presentation for users and application programs.

The prior art has heretofore provided that the dependence on a blown film or cast film manufacturing method of a film web between a setting variable of the manufacturing process and an optical property of the produced film web has been elaborated as empirical value of the operator of the corresponding plant during the operation of the plant. This means that the operator adjusts individually the plant on the base known experience when starting up. In addition, the operator controls during the ongoing production operation of the plant occurring deviations in the optical properties of a film web on the basis of his experience available to him by a corrective intervention on a setting variable.

With increasing complexity of the plants and requirements of the properties of the film web the required experience of an operator of the corresponding plant become steadily more extensive. As a result, the training times of the operator and the requirements for selecting suitable operators had been increased.

In the recent past, it has become increasingly evident that the manifold possibilities of the operator to take influence on the optical properties of a film web due to the complexity of superposition of effects, exceeds the understanding of the plant operator. Thus, not only the expense of the operators of blown film and cast film plants for the selection and training of the operators increases. In addition, the operation of such plants has become increasingly problematic, especially in the production of film webs with special specific properties.

By way of derogation, it is proposed here to derive a systematic dependency in a blown film or cast film production process of a film web between a setting variable of the manufacturing process and an optical property of the produced film web, in that an optical property of the film web and time synchronous or according to the production speed of the film web is determined delayed a parameter of the manufacturing device inline, referring to each other stored in a database and is derived systematically the specific dependence between the parameters.

This systematic dependence developed according to the proposed method between a setting variable of the manufacturing process and an optical property of the film web produced corresponds to the experience of an operator.

With a suitable implementation of the method a systematic dependence is derived from data recorded during the manufacture of a film web and subjected to the intervention of an operator based on his experience.

Examples of optically detectable film properties are:
Gloss level of the foil
Haze
Transparency (opacity)
Optical density of a film
Reflectance
Transmittance
Print image
wrinkle image
Scratches
Surface topography
Layer thicknesses
Single layer thicknesses
Tensions within the film

An essential feature of the invention is the parent and—on each other referring—storage of the data, which consists of an optical property of a film web and a parameter of the manufacturing device from the production of the film web. In order to store the data in relation to each other, it is particularly important to determine the data inline and to store time-synchronously or according to the production speed of the film web with a time offset.

It is understood that in a systematic dependence is meant not necessarily a dependence between two variables/sizes. Rather, a dependency between two variables is meant, however, that dependencies become more probable and commonplace with a variety of variables related to each other with increasing complexity of the plants and film webs.

Advantageously, it can be achieved by the here presented aspect of the invention that a systematic dependence on a blown film or cast film production process of a film web between a setting value of the manufacturing method and an optical property of the produced film web can be derived. This is done during the production of a film web and the intervention of an operator based on his experience. The experiences of experienced plant operators become therefore part of a systematic dependency, as it extends through the experience of the operators to the relevant areas.

Another advantage results from the fact that the systematic dependence is specified continuously during production of a film web. Advantageously, this results for example, to an extension of the systematic dependence on rarely reached, but for the intervention of an operator essential, operating points.

Due to the constant specification of the systematic dependence it results in an advantageous embodiment of the method that the ability to check the robustness of the systematic dependency. Doing so, it can be quantify whether the systematic dependence is a regularity or a tendency with certain and through the constant specification detectable probabilities. Furthermore, in this case, the degree and the probability of the occurrence of a setting variable with respect to an optical property of a film web can be quantified.

A systemic advantage continues to result from the fact that the data can be stored referring on each other. Doing so, it is ensured with a suitable implementation of the process that the data are synchronized in time so that a change in a setting of a variable and the thus reached effect on the optical property of a film web are depicted as sharp and precise as possible. In this case, another essential parameter of the manufacturing device from the production of film web is the production speed of the film web, so that the inline recorded data regarding the change of a setting variable and the resulting effect on the optical property of a film web can be stored with reference on each other.

While operators of a system are subject to emotional action, especially in critical situations, the systematic dependency derived from this aspect of the invention—in a blown film or cast film production process of a film web between a setting variable of the manufacturing method and an optical property of the produced film web—represents an objective description of the facts.

The advantage of the method described here is that it is almost impossible that it can be stored an almost limited variety of parameters based on each other and that a systematic dependence can be derived. An operator of a corresponding plant is in its comprehensibility naturally limited in this regard. In particular an operator reaches often, already, the naturally comprehensibility limit due to the ever increasing complexity of corresponding plants and by the increasing number of achievable properties of a film web product. Furthermore, due to appropriate implementation of the method, a variety of different experiences, in particular also experiences of different operators, are recorded, conserved and used for the derivation of a systematic dependence in a blown film or cast film production method of a film web between an setting variable of the manufacturing process and an optical property of the produced film web.

Thus, in an appropriate implementation of the proposed method, complex relationships between the parameters of the method can be shown. This relates in particular dependencies with a variety of related ones variables, which can have various correlations to each other.

A preferred embodiment can be realized in that the specific dependency of the parameters is determined in the form of a curve with a coefficient of determination (German: Bestimmtheitsmaβ).

Conceptually, the following is explained:

A “coefficient of determination” is a measure of quality, which indicates what percentage of the variance can be explained in the data by a regression model. Indirectly, it is measured so the relationship between the dependent and the independent variables.

Advantageously, its can be achieved so, that the systematic dependence by a curve is specified as a function of a setting variable of the production method, in particular this curve has no gaps, so that a clear assignment between a setting variable and an optical property can be achieved.

The evaluation of a coefficient of determination—from the determined data and that determined by a curve by means of a regression model—gives an indication to the precision of the systematic dependence of a film web between a setting variable of the manufacturing process and an optical property of produced film web, assuming that a sufficient number of data points is present. Advantageously it can be valued so, that how meaningful is a correlation between a setting variable of the manufacturing process and an optical property and how efficiently existing data can be reproduced. In addition, the curve also allows statements in the case of a big coefficient of determination over the edges of existing data. So data can be supplemented and/or extrapolated numerically on the periphery of existing data.

Optionally, the specific dependence of the parameters is determined by a setting range, which is dependent on a predetermined threshold value for the optical property of the film web.

Conceptually, the following is explained:

A “setting range” is an area in which a setting variable can be adjusted. In other words, it is the range of the setting variable between a minimum setting variable setpoint value and a maximum setting variable setpoint value.

A “threshold” is a minimum or maximum manifestation of an optical property of an optical property of a film web.

Advantageously, doing so, it can be achieved both, independent and optional also in combination with each other.

On the one hand, a specific dependency of a film web between a setting variable of the manufacturing process and an optical property of the produced film web depending on a setting range allows that no faulty dependencies may be present, i.e. no statements about non-adjustable setting ranges may be present.

On the other hand, a setting range allows, depending on a given threshold for the optical property of the film web, that due to the systematic dependency of a film web between the setting variable of the manufacturing process and an optical property of the produced film web, only statements about adjustment ranges can be made, that are dependant on a given threshold for the optical property of the film web.

Preference is given to the determination of a specific dependency in the form of an envelope curve, which may called envelope curve or envelope, which is dependant from a threshold value for the optical property of the film web.

Advantageously, it can be achieved in this way, in particular, that systematic dependencies with more than two parameters can be evaluated and displayed.

Likewise advantageous, the limits of an envelope can be limited in dependence of technical restrictions and/or specific requirement profiles, so that the advantages of thresholds for systematic dependencies between two parameters on systematic dependencies can be extended with more than two parameters.

An optional embodiment can be realized in that a measured variable, which describes a geometric or functional property of the film web and has a dependency on an optical property, by means of an optical sensor as a third parameter of the method, is determined, wherein the specific parameter referring to the other parameters are recorded, in ordered way, in a database, and wherein from the data stored in the database, systematically, a specific dependence between the parameters is derived.

Thus, with a suitable implementation of the method, a systematic dependence between the geometric and/or functional property of a film, for example, the water vapour permeability, and an optical property and/or a parameter of the manufacturing device from the production of the film web, can derived.

Examples of functional properties associated with the optical properties of a film can be correlated:
Used raw materials
Proportions of raw materials
Proportions of recycled material
Water vapour permeability
Breathability
Barrier properties
Stretching rate
Flatness location
Thickness
Profile
Stickiness
Uniformity of the stretch result
Molecular orientation
Tensile strength in the machine direction
Tensile strength across the machine direction
Density
Density of foamed polymers, in particular cell size and cell size distribution

Provided that, a systematic dependence between a functional property of a film web and an optical property of a film web is present and/or a systematic dependence between a geometric property of a film web and an optical property of a film web is present, it can be advantageously achieved, that a systematic dependence between a functional property or a geometric property of a film web and an optical property of a film web can be derived.

Provided that, a systematic property between a setting variable of the manufacturing process and just that optical property of the film web produced is present, it can be advantageously achieved that a systematic dependence—between a functional property of a film web and a setting variable of the manufacturing process of the produced film web and/or a systematic dependence between a geometric property of a film web and a setting variable of the manufacturing process of the produced film web—can be derived.

In a preferred embodiment of this method, with a suitable structuring of the process a variety of systematic dependencies—between properties and/or functional and/or geometric properties of a film web and the setting variables of the manufacturing process of the film web and their relationships among themselves—can be derived.

This can allow the analysis of couplings between different parameters and can allow the description of an envelope from achievable properties with the observed manufacturing process for the production of a film web.

A preferred embodiment can be realized in that a measured variable is determined by means of a sensor as a further parameter of the method, in particular a process variable from the spatial environment of the manufacturing process or the manufacturing process of the film web, in particular no setting variable, wherein the determinate parameter, with reference to the other detected parameters, is stored in a database, in ordered way, and from the data systematically stored in the data base a specific dependence between the parameters is derived.

Conceptually, the following is explained:

A “process value” is the current value of a “process variable.” A “process variable setpoint” is the required value for a process variable.

In a suitable design of the proposed method, this may be allow the derivative of a systematic dependence between process variables and an optical property and/or a parameter of the manufacturing device from the production of the film web.

Advantageously, doing so, it can be achieved that often not changeable or only with high energetic or constructive effort changeable process variables in the production of a film web—here is thought for example due to seasonal changes in the temperature and/or humidity—in the systematic characteristics between an optical property of the film web and/or a functional property of a film web and/or a geometric property of a film web and a parameter of the manufacturing device from the production of a film web can be included.

Optionally, the specific dependency between the parameters is systematically derived and, for this, data are used from an existing database.

Advantageously, doing so, it can be achieved that also data from an existing database can be used to derive a systematic dependency. Thus, it can be achieved that at a plant, not at first in the operation of the plant, empirical values are transmitted in data of a database and later must be transferred into a systematic dependence. In this way, existing data and empirical values can be used and time can be saved.

Preferably, the specific dependence between the parameters is derived systematically and for this one already existing database is continuously extended.

In an advantageous embodiment of the invention, data from a database can also tried to compare the current production and quality data with deposited data. In this way, a larger pool of data is available to derive the systematic dependency for the present process, more precisely.

Furthermore, this can advantageously lead to the fact that the coefficient of determination of the data can be continuously improved and/or other dependencies, especially weak correlative dependencies can be detected.

Optionally, the specific dependency between the parameters is systematically derived and only data of a specific manufacturing device are used for this.

Advantageously, this can be achieved that a use of data from different manufacturing devices and/or under other boundary conditions used manufacturing apparatus for film webs can be applied. Thus, a dilution (German: Verwässerung) of data can be avoided, which could negatively affect a coefficient of determination and/or a correlation between parameters.

Preferably, the specific dependence between the parameters is systematically derived and for this data of a plurality of manufacturing devices of identical art are used for the production of film webs.

Advantageously, doing so, it can be achieved that the data available by the evaluation and derivation of a systematic dependency can be quickly multiplied, wherein only data of an identical art are considered, so that art-like dependencies can be excluded.

Optionally, the specific dependency between the parameters is systematically derived and for this data are used from a variety of different art-like manufacturing devices the production of film webs.

Advantageously, doing so, it can be achieved that—by the evaluation and derivation of systematic dependency—available data can be quickly multiplied.

Preferably, the specific relationship between the parameters will be systematically derived and therefore data are used from a variety of manufacturing devices for manufacturing of film webs of a producer and/or many producers.

Advantageously, doing so, it can be achieved that the data—provided for the evaluation and derivation of a systematic dependency—can be quickly multiplied, wherein, thus, only the data of a producer or the data of several producers can be considered.

Optionally, the specific dependency between the parameters is systematically derived and, thus, data are synchronized from a variety of manufacturing devices for manufacturing of film webs with a data cloud.

Advantageously, doing so, it can be achieved, that data—provided for the evaluation and the derivation of a systematic dependency—can be quickly multiplied, wherein, thus, the possibilities of the information technology to synchronize data over a data cloud can be used.

Thus, an effort to synchronize the data can be reduced.

The specific dependence between the parameters is preferably determined heuristically.

Advantageously, doing so, it can be achieved that even with a limited number of data or even with data gaps and with limited temporal resources, a workable systematic dependence can be determined.

Optionally, the specific dependence between the parameters is determined mathematically.

Advantageously, doing so, it can be achieved that the science of mathematics is so used that in the mathematical sense a systematic dependence can be derived as clear as possible.

The specific dependence between the parameters is preferably determined using an optimization method.

In a suitable and advantageous implementation of this method, optimization methods serve to minimize uncertainties of systematic dependencies. In other words, the coefficients of determination of systematic dependencies are maximized. Thus, the description of a systematic dependence is specified.

Furthermore, in an advantageous implementation of the method, an optimization method can be used to uncover, to analyze and to describe multidimensional dependencies between parameters.

Advantageously, doing so, it can be so achieved that the use of optimization methods leads to more precise systematic dependencies and that complex relationships between the data can be better identified and used.

Optionally, the specific dependence between the parameters is determined using a self-learning optimization method.

Advantageously, doing so, it can be achieved that the complex tasks must not be adapted by the use of optimization methods in extensively manner by humans to new conditions. Thus, time and money in the derivation of systematic dependencies can be saved.

A preferred embodiment can be realized in that a measured variable determines optical properties of the film web, in particular the gloss of the film and/or the haze of the film and/or the transparency of the film and/or the optical density of the film and/or the reflectance of the film and/or the transmittance the film and/or the printed image of the film and/or the wrinkle pattern of the film and/or any scratches on the film and/or the surface topography of the film and/or the layer thicknesses of the film and/or the individual (single) layer thicknesses of the film and/or the tension within the film.

Advantageously, doing so, it can be achieved that the derived systematic dependence is dependent on the gloss level of the film and/or haze of the film and/or the transparency of the film and/or the optical density of the film and/or the reflectance of the film and/or the transmittance of the film and/or the printed image the film and/or the wrinkle pattern of the film and/or any scratches on the film and/or to the surface topography of the film and/or to the layer thicknesses of the film and/or to the individual layer thicknesses of the film and/or to the tension within the film.

An optional embodiment can be realized in that a measured variable determines functional properties of the film web depending on the optical properties, in particular the raw materials used and/or the proportion of each raw materials and/or the proportion of recyclate and/or the water vapour permeability of the film and/or the breathability of the film and/or the barrier properties of the film and/or the stretch rate of the film and/or the flatness position of the film and/or the thickness of the film and/or the profile of the film and/or the stickiness (tackiness) of the film and/or the uniformity of the stretch result and/or the molecular orientation of the film.

In a suitable embodiment, additional functional properties of the film web are determined depending on the optical properties of the film web.

Doing so, it can be advantageously achieved, that the derived systematic dependence is dependent on the raw materials used and/or the proportions of the individual raw materials and/or the proportions of recycled material and/or water vapour permeability of the film and/or the breathability of the film and/or to the barrier properties of the film and/or the stretch rate of the film and/or the flatness position of the film and/or to the thickness of the film and/or to the profile of the film and/or to the stickiness of the film and/or the uniformity of the stretch result and/or on the molecular orientation of the film.

According to a second aspect of the invention, the object is solved by a method for adapting the quality of a film web produced in the blown film or cast film process, wherein the quality is measured and adjusted inline, wherein an optical property of the film web is determined by means of a sensor inline on the produced film web, and a setting variable set value is adjusted inline based on the specific optical property, wherein the adjusting of the setting variable is performed by adjusting a actuator, wherein the setting variable set value for the particular optical property is specified by a systematic dependency, that is preferably determined with a method according to the first aspect of the invention and by the adaptation of the setting variable the quality of the film web is so changed that a desired property is increased in its manifestation and/or an undesirable feature is reduced in its manifestation.

Conceptually, the following is explained:

An “actuator element” or “actuator” is particularly suitable for influencing an output variable of a system.

A “manifestation” of a property describes the intensity or frequency with which the property can be perceived. This intensity can be described by a number.

A “control” (German: Steuerung) is an adjustment of a set value.

A “regulation” (German: Regelung) is an interaction of continuous detection of a measured variable and the control of a system as a function of a specification for the measured variable. It takes place a continuous comparison of the measured variable and the specification for the measured variable.

The prior art has heretofore provided that an operator of a plant for manufacturing a film web adjusts the quality of the produced film web according to experience gained by adjusting a setting variable. If the operator notices during the production of a film web occurring quality deviations than he uses empirical values made before again and adjusts a setting variable such that a desired quality of the film web is re-established. This process is performed often iterative until the desired quality of the film web is reached. If resulting deviations in quality occur again, the operator of the plant starts this process again. This state of the art can also be called as user control of the plant for producing a film web.

An optical property of the film web is checked by the operator of a plant for producing a film web often directly or indirectly inline with his eyes. Functional quality features of film web such as the breathability of the film takes place in the prior art, however, not inline. For this purpose, a piece of the film web is taken from the production and analyzed offline.

Methods for adjusting the quality of a produced film web are in the state of the art known, such as from DE 31 07 701 C2, DE 40 33 974 C2, the DE 41 18 122 A1, DE 42 35 163 A1, WO 2007/107147 and the DE 10 2015 006 891 A1.

By way of derogation, it is proposed here to use the systematic dependence obtained according to the first aspect of the invention to adjust the quality of the film web.

In this case, an optical property of the film web is determined inline with a sensor and the systematic dependence obtained according to the first aspect of the invention is used inline for adjusting the quality of the film web, such that the setting value of the manufacturing apparatus for producing the film web—in order to achieve the desired quality of film web—results from the systematic dependence.

A quality adjustment based on a previously obtained systematic dependence is new in the prior art.

Although DE 40 33 974 C2 also discloses a control function depending of a target by the method of the evolution strategy, it should be noted here that the method of evolution strategy works according to the mechanisms of evolution. Thus, “. . . at least partially and/or tendencially random changes in the control parameters, i.e. the setting variables carried out, . . . ” (page 2, The manifold possibilities . . . ). The control of the plant is carried out not on the basis of a previously determined systematic dependence.

DE 41 18 122 A1 discloses a method for regulating the degree of orientation of tube films produced in blown film plants. Thus, it is proposed a desired degree of orientation of the films by adjusting a specific bubble shape in the inflation area of the bubble. Although a systematic dependence between the degree of orientation of the film and bubble form is used, which is determined offline in the laboratory experiment, no systematic dependence between an optical property—here in the broadest sense the shape of the bubble—and a parameter of the manufacturing device for producing the film web is applied. Although “appropriate production parameters have been affected, to bring the actual shape into conformity”, none accordingly descriptive systematic dependency is used. Rather “the parameters for influencing the actual shape of the bubble . . . thus, can be selected in the desired art”.

Advantageously, it can be achieved by the here presented aspect of the invention that the operator of a system for producing a film web may have a lower level of experience. Thus, the selection for suitable operators for the plant for the production of a film web can be simplified. The necessary training measures of the operators may be less focused on transmitting existing experience, and can be accelerate so drastically, because the operator of the plant—if adjusting the quality of the film web—can use a systematic dependency.

The use of a systematic dependency when adjusting a quality of a film web can, furthermore, advantageously lead that changes in the parameters of the plant can be performed less emotionally, whereby the error sensitivity of the quality adjustment process can be reduced.

In addition, the normally iterative process of adjusting the quality of the film during the production of the film can be advantageously accelerated, so that, overall, the proportion of the film web can rise, which has the highest quality features. Corresponding rejects of produced film can thus be reduced.

Furthermore, with the proposed method, the adaptation of the quality of the film web can be automated under adverse conditions.

An adaptation of the quality of the film can, advantageously, be done inline.

The quality of the film web has preferably a geometric property.

Examples of a geometric property are a film thickness profile of the film, a layer thickness profile of the film and a surface structure of the film.

Advantageously, doing so, it can be achieved that the quality of a film can be adapted with respect to the geometric properties of a film web, provided that a direct and/or indirect systematic dependence between an optical property of the film and a geometric property of the film exists.

Consequently, it can be performed inline an automated verification of the quality of geometric properties of a film web, and the operator can be alerted when deviations in a geometric quality of the film web occur.

In addition, the operator can use the systematic dependence between a setting variable of the manufacturing process of film web and a geometric property, advantageously, to perform a fast and robust adjustment of the quality of the film web in terms of geometrical properties.

Thus, a higher level of quality of the produced film web can be ensured and the amount of rejects in the production of a film web can be reduced.

Furthermore, advantageously, it can be achieved that geometric properties of the film web during manufacture are documented and this documentation can be made available to the customer of the film web. Thus, the customer's trust can be increased with respect to the film web product.

Geometric properties of a film web can be maintained according to desired specifications, if a direct and/or indirect systematic dependence between an optical property of the film and a geometric property the film is made.

Optionally, the quality of the film web has an optical property.

Examples of an optical property of a film web are the transparency of a film, the optical density of a film, the reflectance of a film, the transmittance of a film, the printed image of a film and the wrinkles image of a film.

Advantageously, it can be achieved so, that the quality of a film can be adapted in terms of optical properties of a film web.

Consequently, an inline automated inspection of the quality of optical properties of a film web can be performed and the operator can be alerted in case of deviations in an optical quality of the film web.

In addition, the operator can use the systematic dependence between a setting variable of the manufacturing process of film web and an optical property, advantageously, to perform a fast and robust adjustment of the quality of the film web in terms of an optical property.

Thus, a higher level of quality of the produced film web can be ensured and the amount of rejects in the production of a film web can be reduced.

Furthermore, it can be advantageously achieved that optical properties of the film web are documented during manufacture and this documentation can be made available to the customer of the film web. Thus, the customer trust can be increased with respect to the film web product.

Optical properties of a film web can be reached according to desired specifications.

The quality of the film web can preferably have a functional property.

Examples of a functional property of a film web are the water vapour permeability of a film, the breathability of a film, the barrier properties of a film, the stretch rate of a film and the flatness position of a film.

Advantageously, doing so, it can be achieved that the quality of a film can also be adapted in terms of to the functional properties of a film web, provided that a direct and/or indirect systematic dependence between an optical property of the film and a functional property of the film exists.

Consequently, an automated check of the quality of functional properties of a film web can be carried out inline and the operator can be alerted when deviations in a functional quality of the film web occur.

In addition, the operator can advantageously use the systematic dependence between a setting variable of the production process of the film web and a functional property to perform a fast and robust adaptation of the quality of the film web with regard to a functional property.

Thus, a higher level of quality of the produced film web can be ensured and the amount of rejects in the production of a film web can be reduced.

Furthermore, it can be advantageously achieved that functional properties of the film web during manufacture are documented and this documentation can be made available to the customer of the film web. Doing so, the customer trust to the film web product can be increased.

Functional properties of a film web can be maintained according to desired specifications, provided that a direct and/or indirect systematic dependence between an optical property of the film and a functional property of the film exists.

A preferred embodiment can be realized in that the quality of the film is adjusted inline and that it corresponds to the desired quality of the film web, i.e. has no measurable disturbances/disturbance variables.

Conceptually, the following is explained:

A “disturbance variable” is a parameter having a deviation from its ideal state.

Thus, the quality of the film is adapted inline with a suitable design. Under an inline adaptation of a quality of the film is understood as an automated control of the adaptation of the quality of a film web.

It is conceivable, among other things, that the quality of the film web can be continually adjusted inline, in such a way that the quality of the film web is controlled within defined quality limits. In other words, the quality of the film web can be adjusted in such a way that no more—due a systematic dependence with optical methods—measurable disturbances occur.

Advantageously, doing so, it can be achieved that defined quality requirements for a film web can be maintained, automated inline.

This drastically reduces the rejects of produced film.

Advantageously, it can also be achieved that an operator of the plant for the production a film web can be relieved by the automated control of the quality properties of the film web. As a result, the operators can focus more attention on other process requirements. Consequently, the level of training of the operators of the plant in the area of quality monitoring and quality control can be also reduced.

Optionally, the desired quality of the film web is specified manually.

In a suitable implementation of this feature, an operator may choose/set the desired quality requirements of a film web manually. So it is also possible to manually respond to a change in the desired quality properties of a film web, and the product can be easily adapted to the wishes of another customer and/or to another purpose.

Advantageously, doing so, it can be achieved that an operator of a plant for producing a film web can adapt quickly and easily the desired quality of the film web manually to the requirements of production.

Preferably, the desired quality of the film web is automatically specified.

Thus, in a suitable embodiment, a distinction can be made between different types, which are in terms of their quality requirements technically with respect to information relevant and which can perform the superordinate production control automated adjustment with regard to the desired quality requirements.

Advantageously, doing so, it can be achieved that the probability of quality requirement characteristics that do not fit to each other can be reduced. Thus, is can be guaranteed that different quality requirements of a film web are set to match each other, so that they meet the product requirements.

Optionally, more than one measured variable, which covers in particular optical properties of the film web, are measured as a parameter of the method by means of one or more sensors inline on the produced film web.

In a suitable embodiment, an equal measuring method can be used at different positions in the process of the foil production.

In another suitable embodiment, different measuring methods can be used at the same position and/or at different positions in the process.

Advantageously, doing so, it can be achieved with the use of additional measuring means that additional knowledge for the derivation of a systematic dependence are gained.

Furthermore, it can be advantageously achieved that quality requirements can be monitored at different locations.

In addition, the possibility may arise to increase the number of monitorable and/or customizable quality features.

Preferably the systematic dependence takes into account—which describes the setting variable depending from the measured variable—the process parameters of the film production.

The process parameters can be understood to mean all parameters which have not yet been mentioned otherwise and which can be measured. In particular, the process parameters can also be subsumed under the process parameters.

Advantageously, doing so, it can be achieved by adapting the quality of a film web that also significant process parameters can be considered. Essential process parameters are all parameters that affect the process of producing a film web.

Optionally, the measured variable of the quality of the film web is determined with an optical measuring system.

Advantageously, doing so, it can be achieved that the quality of the film web can be determined and monitored with an optical measuring system. Subsequently, the operator or an automatic plant control can perform an adjustment of the quality of a film in response to the signals from the optical measuring system.

The measured variable of the quality of the film web is preferably measured on the basis of the optical properties of the film.

Advantageously, doing so, it can be achieved that the quality of the film web can be by determined and monitored on the basis of optical properties and can be monitored. Subsequently, the operator or an automatic plant control can adjust the quality of a film in response to the optical properties of a film.

A preferred embodiment can be realized in that the quality of the film web is adjusted/changed with the nozzle unit in the blow head, in particular an annular nozzle in a blown film plant or a wide slot nozzle in a cast film plant.

Thus, in a suitable embodiment, the quality of a film web ca be adjusted, for example by the thickness of a film, by a single layer thickness of a film, by a number of individual layer thicknesses of a film, by the temperature of a component, by the temperature profile of a component and/or the total pressure of a component.

Advantageously, doing so, it can be achieved that a variety of different settings options in the environment of the nozzle unit can be used to adjust the quality of a film web.

Optionally, the quality of the film web is adjusted/changed by the recipe of the plastic melt.

Advantageously, doing so, it can be achieved that the quality of a film web can be adjusted through the adjustment of the recipe of the plastic melt.

Preferably, the quality of the film web is adjusted by the stretching of the film.

The stretching of a film web allows the film web to equip with product properties which depend on the degree of stretching and the orientation of the stretching of the film.

Advantageously, doing so, it can be achieved that the quality of a film web can be also adjusted depending on the stretching of the film.

Optionally, the quality of the film web is adjusted with an aftertreatment section.

An aftertreatment section allows by various activities, for example, the temperature control (change) and/or voltage control (change) and/or surface treatment of a foil to provide special product properties.

Advantageously, it can thereby be achieved that the quality requirements for a film web can also include the product properties, which can be caused and/or changed by the aftertreatment.

An optional embodiment can be realized in that a property measuring system determines optical properties of the film web, in particular the degree of gloss of the film and/or the haze of the film and/or the transparency of the film and/or the optical density of the film and/or the reflectance of the film and/or the transmittance of the film and/or the printed image of the film and/or the wrinkle image the film and/or any scratches on the film and/or specks and/or the surface topography of the film and/or the layer thicknesses of the film and/or the single layer thicknesses of the film and/or a layer shift of the film and/or the tension within the film.

Advantageously, it can thereby be achieved that the adaptation of the quality of a film web extends also on the optical properties of a film web, in particular the degree of gloss of the film and/or the haze of the film and/or the transparency the film and/or the optical density of the film and/or the reflectance of the film and/or the transmittance of the film and/or the printed image of the film and/or the wrinkled image of the film and/or any scratches on the film and/or specks and/or the surface topography of the film and/or the layer thicknesses of the film and/or the single layer thicknesses of the film and/or a layer shift of the film and/or the tension within the film.

A preferred embodiment can be realized in that the property measuring system determines the functional properties of film web depending on the optical properties, in particular the raw materials used and/or the proportion of individual raw materials and/or the proportion of recyclate and/or the water vapour permeability of the film and/or the breathability of the film and/or the barrier properties of the film and/or the stretching rate of the film and/or the flatness position of the film and/or the thickness of the film and/or the profile of the film and/or the tackiness of the film and/or the uniformity of the stretching result and/or the molecular orientation of the film.

Advantageously, doing so, it can be achieved that the adaptation of the quality of a film web extends also on the functional properties of a film web, in particular the raw materials used and/or the proportions of the individual raw materials and/or the proportion of recyclate and/or the water vapour permeability of the film and/or the breathability of the film and/or the barrier properties of the film and/or the stretching rate of the film and/or the flatness position of the film and/or the thickness of the film and/or the profile of the film and/or the tackiness of the film and/or the uniformity of the stretching result and/or the molecular orientation of the film.

Preferably, the setting variable set value in the manufacturing process of the film web is determinate to affect the quality of the film by a suitable specific algorithm.

Conceptually, the following is explained:

An “algorithm” is a clear rule of action for solving a problem or a class of problems. The algorithm consists of finitely many, well-defined individual steps. Thus, they can be implemented for execution in a computer program, but also formulated in human language. When solving a problem a specific input is transferred into a specific output.

Advantageously, it can thereby be achieved that the adaptation of the quality requirements of a film web is taken over automated by an appropriate specific algorithm. Thus, it can be ensured that in the adjustment of quality film web only systematic errors can occur. These can, however, be eliminated by adjustment of the specific algorithm.

A preferred embodiment can be realized in that the setting variable set value in the manufacturing process of film web is determined for affecting the quality of film by a suitable specific algorithm, wherein the algorithm uses an in-line deviation, i.e. the difference from the desired quality of the film and the measured quality of the film, as input variable.

Thus, in a suitable embodiment a closed regulation loop for the adjustment of the quality of the film web can be used. By using the control deviation, a disturbance variable can be corrected to zero after a settling time.

Advantageously, it can thereby be achieved that determined disturbance variables can be adjusted automatically by a controller. Thus, highest demands on the product quality can be adhered and guaranteed.

It should be expressly understood that the subject of the second aspect can be advantageously combined with the object of the first aspect of the invention, namely both, individually or in any combination cumulatively.

According to a third aspect of the invention, the object is solved by a method for adaptation of the quality of a film web produced by blown film method or cast film method, whereby the quality is measured inline and is adjusted, wherein the quality of the film is so adjusted by adjusting a setting variable set value/setpoint such that an error image of a second error—especially complete—is reduced to conclude—due an in relation to the error image of the second error more increasing error image of a first error—to the dimension of the first error.

Conceptually, the following is explained:

An “error” is the deviation of a condition that is determined related to the desired condition. Here, in particular, an error is to understand as in the optical property of the film web. An error thus describes a deviation from the desired optical property of the film web.

An “error image” is a two-dimensional or three-dimensional representation of an error.

The prior art has heretofore provided that an operator of a plant for manufacturing a film web adjusts the quality of the produced film web according to experience gained by adjusting a setting variable. Notices the operator during the production of a film web quality deviations, than he makes use of empirical values made again and adjusts the setting variable so that a desired quality of the film web is re-established. This process often is carried out iterative until the desired quality of the film web is reached. When deviations in quality occur again, the operator of the plant starts this process again. This state of the art can also be called as user control of the plant for producing a film web.

By way of derogation, it is proposed here that the systematic dependence obtained according to the first aspect of the invention is used to adjust the quality of the film web, wherein an error image of a second error is reduced—in particular completely—in order to conclude—to an in relation to the error picture of the second error becoming more stronger error picture of the a first error—to the dimension of the first error.

In this case, an optical property of the film web is determined inline with a sensor and the systematic dependence obtained according to the first aspect of the invention is used inline for adjusting the quality of the film web such that the required setting value emerges in order to achieve the desired quality of film web of the manufacturing apparatus for producing the film web from the systematic dependence.

The quality of a film web, in particular the quality based on optical properties of a film web, has often several error images, which can be depend or independent on each other.

Concretely, among other things, it is conceivable that a wrinkle pattern/image of a film web is reduced—especially completely—as an error image of a second error to conclude due to a—in relation to a wrinkle pattern of a film web—becoming stronger error of a scratch as error image of a first error, to the dimension of the scratch.

Thus, it is also concretely conceivable inter alia that a haze of a film web is reduced as an error image of a second error—especially complete—to conclude due to a—in relation to a haze of a film web—becoming stronger image error as error image of a first error, to the dimension of the scratch

Advantageously, it is thereby achieved by the method proposed here that an error pattern of a second error—especially complete—can be reduced, so that the error image of a first error can be detected with a determination of an optical property of the film web more accurately or equally well.

Preferably, the quality of the film is adjusted by adjusting a setting variable set value/setpoint such that the error image of the first error—especially completely—is reduced.

Advantageously it can be thereby achieved that a film web can be produced in such a way that error images can be automatically reduced and/or can be ideally completely reduced.

It should be expressly understood that the subject matter of the third aspect can be combined advantageously to the subject matter of the above aspects of the invention, namely either individually or in any combination cumulatively.

According to a fourth aspect of the invention, the object is solved by a method for manufacturing a film web, wherein a blown film or cast film plant is operated, wherein during the manufacturing process, a method according to a first and/or second and/or third aspect of the invention is performed.

It is understood that the advantages of a method for indirectly deriving a systematic dependence between a setting variable and an optical property of a film web and/or a method for adjusting the quality of a film web, as described above, extends directly to a method for producing a film web, wherein a blown film or cast film plant is operated, wherein during the manufacturing process, a method according to a first and/or second aspect of the invention is carried out.

It should be expressly understood that the subject matter of the fourth aspect can be advantageously combined with the subject matter of the above aspects of the invention, namely either individually or in any combination cumulatively.

According to a fifth aspect of the invention, the object is solved by a device for producing a film web, wherein the device comprises an extruder for plasticizing a thermoplastic, a nozzle for the escape of the plastic, a deflection and a winder, wherein the device has an actuator for inline affecting the quality of the film and a data processing and evaluation unit, wherein the data processing and evaluation unit has a programming, wherein the programming is performed for carried out a method according to a first and/or second and/or third and/or fourth aspect of the invention.

Conceptually, the following is explained:

A “data processing and evaluation unit” is an electronic unit that operates organized data sets and, thus, pursues the goal of providing information due to gain these data sets or to change these data sets. The data are recorded in data records, and output a result according to one of the prescribed methods by human or machine processing.

It is understood that the advantages extends to a method for indirectly deriving a systematic dependence between a setting variable and an optical property of a film web and/or a method for adjusting the quality of a film web and/or a method for producing a film web, wherein a blown film or cast film plant is operated, wherein during the manufacturing process a method is performed according to a first and/or second and/or third aspect of the invention as described above—extends—directly on a device for producing a film web, wherein the device comprising an extruder for plasticizing a thermoplastic plastic, a nozzle for the escape of the plastic, a deflection and a winder, wherein the device comprises an actuator for inline affecting the quality of the film and comprises a data processing and evaluation unit, wherein the data processing and evaluation unit has a programming, wherein the programming is designed to perform a method according to a first one and/or second and/or third and/or fourth aspect of the invention.

The device preferably has a property measuring system for inline detection of an optical property of the film web.

Advantageously, it can thereby be achieved that an optical property of a film web is determined inline, evaluated, and can be used for the derivation of a systematic property, for process monitoring, in particular for quality monitoring, and for adjusting the quality of the film web.

Optionally, the device has a measured variable measuring system for determining a measured variable of the production process, in particular a process variable.

Advantageously, it can be achieved thereby that a property of the production process of a film web is by inline determined, evaluated, and for deriving a systematic property, for process monitoring, especially for quality monitoring, as well as for adjusting the quality of the film web.

Preferably, the device has a setting variable measuring system for determining a setting variable of the production process.

Thus, thereby, is can advantageously be achieved that a setting variable of the manufacturing device for producing a film web can be inline determinate, evaluated, and can be used for deriving a systematic property, for process monitoring, in particular for quality monitoring, as well as for adjusting the quality of the film web.

Optionally, the device includes an actuator for inline affecting the quality of the foil with segmented control zones.

Advantageously, thereby, it can be achieved that an actuator can be used for adjusting the quality of a film web.

The device is designed for producing a film web, in particular in the form a blown film or a cast film formed.

Advantageously, doing so, it can be achieved that a film web can be produced on a suitable manufacturing device, in particular on a blown film plant or a cast film plant.

It should be expressly understood that the subject matter of the fifth aspect can be advantageously combined with the subject matter of the above aspects of the invention, namely either individually or in any combination cumulatively.

The invention will be described below with reference to an exemplary embodiment explained in detail on the drawing. It is shown:

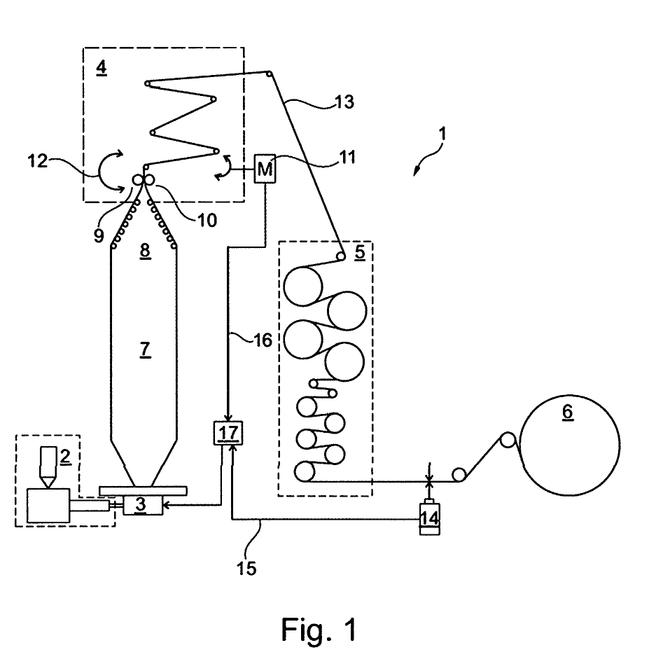

FIG. 1 shows a schematic view of a blown film plant,

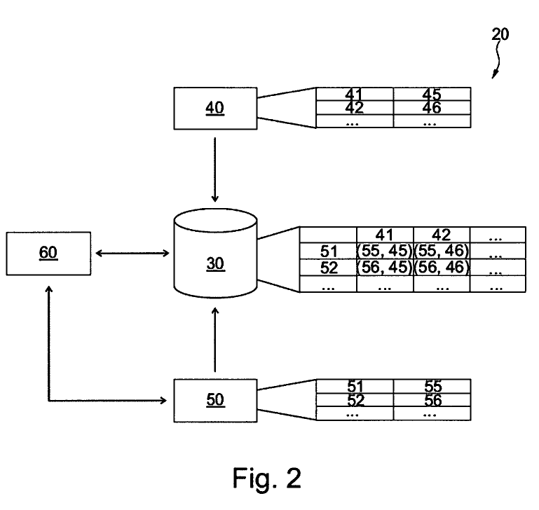

FIG. 2 shows a schematic representation of a data processing system and

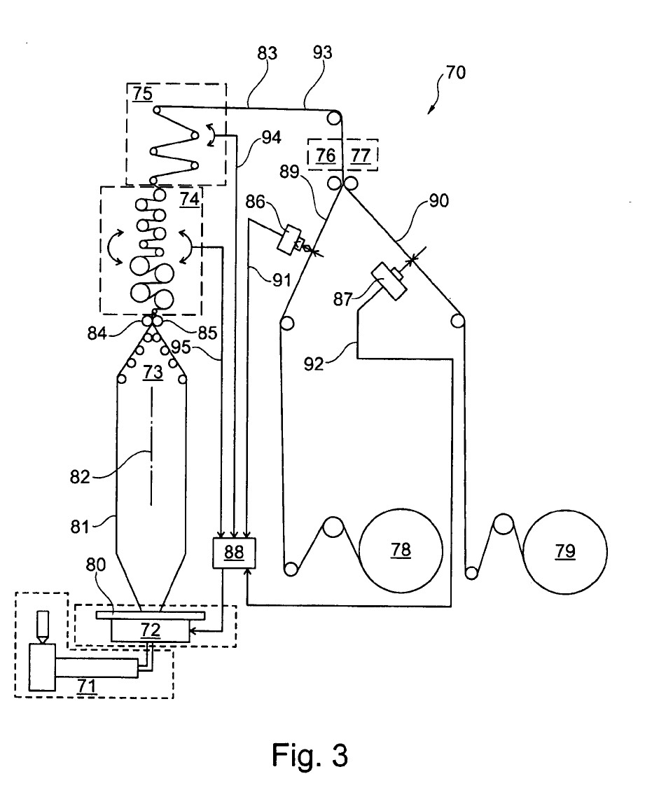

FIG. 3 shows in schematic view an alternative blown film plant.

The blown film plant 1 in FIG. 1 consists essentially of an extruder 2, a blow head 3, a reversing turn-out 4, a treatment section 5 and a winder 6.

The extruder 2 conveys and plasticizes a plastic melt. To the plastic melt is added as an additive calcium carbonate in the extruder 2. The plastic melt passes through an annular gap nozzle (not numbered) in a blow head 3. The leaving plastic melt forms a film bubble 7, which is pulled in a flattening part 8 from a pair of take-off rollers 9, 10 to a folded, doubly flattened film web 13.

The doubly flattened film web 13 is further taken and leaded into the reversing turn-out 4 (German: Wendeabzug).

The reversing turn-out is driven by a motor 11 and performs a reversing movement 12, through which any deviations occurring in the film thickness profile of the doubly flattened film web 13 are laid.

Behind the reversing turn-out 4, the double flattened film web is fed into the treatment section 5, which stretches the double-laid flat film web 13 in this embodiment monoaxially inline in the machine direction.

Behind the treatment section 5, the doubly flattened film web 13 is fed to the winder 6 and is there wound up to a film wrap.

The calcium carbonate added as an additive to the starting material dims the film web.

Between the treatment section 5 and the winder 6 passes the double flattened film web 13 to a measuring system 14 for detecting an optical property 15 of the produced double-laid film web 13.

The optical property 15 of the doubly flattened film web 13 is here in particular the transmittance. Specifically, the transmission gives the double flattened film web 13 depending on the value, inhomogeneity and course in particular information on any deviations in the stretching, in the film thickness profile or the homogeneity of the melt.

The transmission of the doubly flattened film web 13 is determined with a through-transmitted light procedure. In this case, light is projected onto the doubly flattened film web 13, and the transmission is determined from the reflected part of the light.

Different types of light can be used. Conceivable types of light are in particular laser light and/or white light and/or LED light and/or infrared light. Conceivable, however, are any other types of light.

The optical property 15 of the doubly flattened film web 13 becomes common fed with a reversing angle 16 of the reversing turn-out 4 of a data processing and evaluation 17.

The data processing and evaluation unit 17 is adapted to carry out a method for indirect derivation of a systematic dependence of a film web between a setting variable of the manufacturing process, in particular a setting variable of the annular gap of the blow head 3, and an optical property 15 of the produced double flattened film web 13 and a method for adjusting the quality of the produced twice flattened film web 13, wherein the quality is measured inline and is adjusted by means of a setting variable of the annular nozzle of the blow head 3.

The quality influences are evaluated with a corresponding algorithm from the determined, the film quality descriptive optical property 15, wherein a systematic dependence of the involved parameters is used and is used for adaptation of the film quality of the double flattened film web 13.

A data processing system 20 for a plant for producing a film web consisting of a database 30, a measuring system 40 for determining an optical film characteristic of a film, a setting variable system 50 for monitoring, recording and adjusting a setting variable and a data detection and evaluation unit are shown schematically in FIG. 2.

The setting variable system 50 is connected to the annular slit nozzle of a blow film plant. The setting variables are the in adjustment sectors divided slot widths 51, 52 of the annular slit nozzle with the setting values 55, 56. The points represented in the data element of the setting variable system 50 make clear that there can be a large number of adjustment sectors. By way of example, two adjustment sectors are considered here.

The recorded data of the setting variable system 50 is sent forwarded to the database 30.

The measuring system 40 determines the optical properties 45, 46 of the film web in measuring sectors 41, 42. The points illustrated in the data element of the measurement system 40 illustrate that there can exist a plurality of measuring sectors. Exemplary here considered are two measuring sectors.

The recorded data of the measuring system 40 are forwarded to the database 30.

Database 30 allocates the data and assigns them to data points (55, 45), (55, 46), (56, 45), (56, 46), respectively. These data points are continuous saved.

The data detection and evaluation unit 60 can access the data elements of the database 30.

The data detection and evaluation unit 60 performs with the data elements of the database 30 an indirect method of deriving a systematic dependency of a film web between a setting variable with the corresponding setting values 55, 56 of the manufacturing process and the optical properties 45, 46 of the produced film web.

The resulting systematic dependency is also stored in the database 30 (not shown here).

Furthermore, the data detection and evaluation unit 60 performs a method of adjusting the quality of a film web. Thereby, the data detection and evaluation unit 60 uses the inline measured optical properties 45, 46 of the film web, compares it with quality specifications for the optical properties of the film web and carries out in the case of deviations from the required quality the method for adjusting the quality of the film web.

The method of adjusting the quality of the film web utilizes the systematic dependence of a film web between a setting variable and the corresponding setting values 55, 56 of the production method and the optical properties 45, 46 of the produced film web. In this case, the setting values 55, 56 are adapted corresponding to the systematic dependence in dependence of the optical properties 45, 46.

To make this adjustment, the data detection and evaluation unit 60 communicates with the setting variable system 50, which performs and monitors the adjusting of the setting values 55, 56.

The blown film plant 70 in FIG. 3 consists essentially of an extruder 71, a blow head 72, a flattening part 73, a treatment section 74, a reversing turn-out 75, optionally a slot device 76 or a seam station 77 (Germen: Besäumstation), a first winder 78, a second winder 79, a first measuring system 86, a second measuring system 87 and a data detection and evaluation unit 88.

The extruder 71 conveys and plasticizes during operation of the blown film unit 70 a plastic melt, which is conveyed into the blow head 72.

The blow head 72 has an annular gap nozzle 80 divided into adjusting segments (not shown).

The plastic melt emerging from the blow head 72 forms a film bubble 81, which has an axis 82 and is folded in the flattening part 73 to a double flattened film web 83.

The doubly flattened film web 83 is withdrawn from a pair of take-off rollers 84, 85 and further passed into the treatment section 74.

The treatment section 74 stretches the double flattened film web 83. After the treatment path 74 the double flattened film web 83 runs in the machine direction into the reversing turn-out 75.

Behind the reversing turn-out 75 the double flattened film web 83 passes optionally a slot device 76 or a seam station 77.

The slot device 76 slits the double flattened film web 83 into or into the direct vicinity of the two folding edges, so that from the doubly flattened film web 83 two superimposed film webs 89, 90 are made.

The seam station 77, which is used as an alternative, cuts in the vicinity of the two folding of the double flattened film web 83, each, an edge strip of double flattened film web 83, so that from the doubly flattened film web 83 two superimposed film webs 89, 90 are made. When using a seam station 77 the edge strips (not shown) are removed with an edge strip removing part (not imaged).

Behind the optionally used slot device 76 or seam station 77 the superimposed film webs 89, 90 are separated from each other and then pass through a measuring system 86, 87 for detecting an optical property 91, 92 of the manufactured film webs 89, 90 and are fed finally, each, to one winder 78, 79 and wound there, each, to a film wrap.

As an alternative to the use of two measuring systems 86, 87 at low temporal rates of change of the optical property 93 of the double flattened film web 83 only a measuring system 86 can be used for detecting an optical property 91 of the produced film web 89, since this is due to the laying of the folds (not formed) representative by the reversing turn-out 75 by 180° relative to the circumferential angle (not shown) of the film bubble 81 of the double flattened film web 83 at low temporal change rates of the optical property 93 of the optical property 93 of the double-laid film web 83.

The optical properties 91, 92 of the film webs 89, 90 produced are here in particular the transmittance. Specifically, the transmission of the film web 89, 90 depending on the value, the inhomogeneity and the course gives, in particular, information about any deviations in the stretching, in the film thickness profile or the homogeneity of the melt.

The transmission of the film webs 89, 90 is determined by a transmitting-through light method. In this case, light is projected onto the film web 89, 90, and from the reflected part of the light the transmission is determined.

Different types of light can be used. Conceivable types of light are in particular laser light and/or white light and/or LED light and/or infrared light. Conceivable, however, are any other types of light.

The optical property 91, 92 of the film webs 89, 90 is given together with a reversing angle 94 of the reversing turn-out 75 and a treatment section angle 95 of the treatment section 74 of a data processing and evaluation unit 88.

The data processing and evaluation unit 88 is configured to perform a method for indirect derivation of a systematic dependence of a film web between a setting variable of the manufacturing method, in this case in particular a setting variable of the annular gap nozzle 80 of the blow head 72, and an optical property 91, 92 of the produced film web 89, 90 and a method for adjusting the quality of the produced film web 89, 90, wherein the quality is inline measured and adjusted by means of a control of a setting variable of the annular gap nozzle 80 of the blow head 72.

The quality influences are evaluated with a corresponding algorithm from the determined, the film quality descriptive optical property 91, 92, wherein a systematic dependence of the parameters involved is formed and is used for adaptation the film quality of the film web 89, 90.

### LIST OF REFERENCE NUMBERS USED

1 blown film plant

2 extruder

3 blow head

4 reversing turn-out

5 treatment section

6 winder

7 foil bubble

8 flattening part

9 take-out roll

10 take-out roll

11 motor

12 reversing movement

13 double laid film web

14 measuring system

15 optical property

16 reversing angle

17 data processing and evaluation unit

20 data processing system

30 data base

40 measuring system

41 measuring sector

42 measuring sector

45 optical property

46 optical property

50 setting variable system

51 slot width

52 slot width

55 setting value

56 setting value

60 data detection and evaluation unit

70 blown film plant

71 extruder

72 blow head

73 flattening part

74 treatment section

75 reversing turn-out

76 slot device

77 seam station

78 winder

79 winder

80 annular gap nozzle

81 foil bubble

82 axis

83 double laid film web

84 take-out roll

85 take-out roll

86 measuring system

87 measuring system

88 data detection and evaluation unit

89 film web

90 film web

91 optical property

92 optical property

93 optical property

94 reversing angle

95 treatment section angle

1.

2.

3. Method for indirectly deriving a systematic dependency in a blown film or cast film production process of a film web between a setting variable of the manufacturing process and an optical property of the produced film web,
characterized in that
an optical property of the film web is determined as a first parameter of the process inline on the produced film web by means of a sensor,
a second parameter of the method is determined, in particular a parameter of the manufacturing device from the production of film web, in particular the setting variable of the production process is determined,
a data detection system digitalizes and records the parameters as needed,
the determinate parameters are stored in an orderly manner, related to each other
and from the, in a data base stored, data the dependence between the parameters is derived systematically.

2. Method according to claim 1, characterized in that the specific dependence of the parameters is determined in form of a coefficient of determination comprising curve.

3. Method according to claim 1, characterized in that the specific dependency of the parameters is determined by a setting range, which is depended on a given threshold value for the optical property of the film web.

4. Method according to claim 1, characterized in that the specific dependence is determined in the form of an envelope curve, which is depending on a given threshold value for the optical property of the film web.

5. Method according to claim 1, characterized in that a measured variable, which describes a geometric or functional property of film web and is dependant on an optical property, is determined by means of an optical sensor as a third parameter of the method, wherein the determined parameter is stored in a data base in ordered manner with reference to the detected parameters according to claim 1, and whereby from the—in the data base stored—data systematically a specific dependency between the parameters is derived.

6. Method according to claim 1, characterized in that a measured variable is determined by means of a sensor as a further parameter of the method, in particular a process variable from the spatial environment of the manufacturing process or the production process of the film web, in particular none setting variable, wherein the specific parameter is stored in a data base in ordered manner referring to the parameters detected according to one of the preceding claims, and a specific dependence between the parameters is derived from the data stored in the data base systematically.

7. Method according to claim 1, characterized in that the specific dependency between the parameters is systematically derived and therefore data from an existing database are used.

8. Method according to claim 1, characterized in that the specific dependency between the parameters is systematically derived and for that an already existing database is continuously extended.

9. Method according to claim 1, characterized in that the specific dependence between the parameters is derived systematically and for that only data of a specific manufacturing device are used.

10. Method according to claim 1, characterized in that the specific dependence between the parameters is systematically derived, and for that data from a plurality of manufacturing devices are used for the production of film webs.

11. Method according to claim 1, characterized in that the specific dependence between the parameters is derived systematically, and for that data from a variety of manufacturing devices of different art are used for the production of film webs.

12. Method according to claim 1, characterized in that the specific dependence between the parameters is derived systematically, and for that data from a variety of manufacturing devices are used for the production of film webs of a producer and/or many producers.

13. Method according to claim 1, characterized in that the specific dependence between the parameters is systematically derived, and for that data from a plurality of manufacturing devices for producing film webs are synchronized with a data cloud.

14. Method according to claim 1, characterized in that the specific dependence between the parameters is determined heuristically.

15. Method according to claim 1, characterized in that the specific dependence between the parameters is determined mathematically.

16. Method according to claim 1, characterized in that the specific dependence between the parameters is determined by an optimization method.

17. Method according to claim 1, characterized in that the specific dependence between the parameters is determined by a self-learning optimization method.

18. Method according to claim 1, characterized in that a measured variable determines the optical properties of the film web, in particular the degree of gloss of the film and/or the haze of the film and/or the transparency of the film and/or the optical density of the film and/or the reflection grad of the film and/or the transmittance of the film and/or the printed image the film and/or the wrinkle image of the film and/or any scratches on the film and/or the surface topography of the film and/or the layer thicknesses of the film and/or the single layer thicknesses of the film and/or the tension within the film.

19. Method according to claim 1, characterized in that a measured variable determines functional properties of the film web in dependence of the optical properties, in particular the raw materials used and/or the proportions of the individual raw materials and/or the proportion of recycled material and/or the water vapour permeability of the film and/or the breathability of the film and/or the barrier properties of the film and/or the stretch rate of the film and/or the flatness position of the film and/or the thickness of the film and/or the profile of the film and/or the tackiness of the film and/or the uniformity of the result of stretching and/or the molecular orientation of the film.

20. Method for adjusting the quality of a with a blown film or cast film process manufactured film web, whereby the quality is measured and adjusted inline,
characterized in that
an optical property of the film web is determined by means of a sensor inline on the produced film web,
and a setting variable set value is adjusted inline based on the determined optical property,
wherein the adjusting the setting variable is performed by adjusting an actuator,
wherein the setting variable set value is described for the specific the optical property by a systematic dependency, which is preferably determined by a method of claim 1,
and by adjusting the setting variable the quality of the film web is changed such that a desired property is increased in its manifestation and/or an undesirable property is reduced in its manifestation.

21. Method according to claim 20, characterized in that the quality of the film web has a geometric property.

22. Method according to claim 20, characterized in that the quality of the film web has an optical property.

23. Method according to claim 20, characterized in that the quality of the film web has a functional property.

24. Method according to claim 20, characterized in that the quality of the film is adjusted inline and that it corresponds to the desired quality to the film web, so that it does not have measurable disturbances.

25. Method according to claim 20, characterized in that the desired quality of the film web is specified manually.

26. Method according to claim 20, characterized in that the desired quality of the film web is automatically specified.

27. Method according to claim 20, characterized in that more than one measured variable, which in particular detect optical properties of the film web, are measured inline on the produced film web as parameters of the method by means of one or more sensors.

28. Method according to claim 20, characterized in that the systematic dependency, which specifies the setting variable depending on the measured value, considers the process parameters of film production.

29. Method according to claim 20, characterized in that the measured value of the quality of the film web is determined with an optical measuring system.

30. Method according to claim 20, characterized in that the measured value of the quality of the film web is measured based on the optical properties of the film.

31. Method according to claim 20, characterized in that the quality of the film web is adjusted with the nozzle unit, in particular an annular nozzle in the blow head in a blown film plant or a wide slot nozzle in a cast film plant.

32. Method according to claim 20, characterized in that the quality of the film web is adjusted by the recipe of the plastic melt.

33. Method according to claim 20, characterized in that the quality of the film web is adjusted by the stretching of the film.

34. Method according to claim 20, characterized in that the quality of the film web is adjusted with an aftertreatment section.

35. Method according to claim 20, characterized in that a property measurement system determines optical properties of the film web, in particular the degree of gloss of the film and/or the haze of the film and/or the transparency of the film and/or the optical density of the film and/or the reflectance of the film and/or the transmittance of the film and/or the print image of the film and/or the wrinkle image of the film and/or any scratches on the film and/or specks and/or the surface topography of the film and/or the layer thicknesses of the film and/or the single layer thicknesses of the film and/or the layer shift of a film and/or the tension within the foil.

36. Method according to claim 20, characterized in that the property measuring system determines functional properties of the film web depending on the optical properties, in particular the used raw materials and/or the proportions of individual raw materials and/or the proportion of recyclate and/or the water vapour permeability of the film and/or the breathability of the film and/or the barrier properties of the film and/or stretch rate of the film and/or the flatness position of the film and/or the thickness of the film and/or the profile of the film and/or the tackiness of the film and/or the uniformity of the stretch result and/or the molecular orientation of the film.

37. Method according to claim 20, characterized in that the setting variable set value in the production process of the film web for affecting the quality of the film is determined via a suitable specific algorithm.

38. Method according to claim 20, characterized in that the setting variable set value in the production process of the film web for affecting the quality of the film is determined via a suitable specific algorithm, wherein the algorithm uses an inline control deviation, i.e. the difference between the desired quality of the film and the measured quality of the film as input value.

39. Method according to claim 20,
characterized in that
the quality of the film is adjusted by adjusting a setting variable set value by reducing an error image of a second error—in particular completely—in order to have an—compared with the error image of the second error—more increasing error image of a first error, to conclude to the dimension of the first error.

40. Method according to claim 39, characterized in that the quality of the film is adjusted by adjusting a setting variable set value, in that the error image of the first error—especially complete—is reduced.

41. Method for producing a film web, wherein a blown film or cast film plant is operated during the manufacturing process, wherein during the manufacturing process, a method is carried out according to claim 1.

42. Device for producing a film web, wherein the device comprises an extruder for plasticizing a thermoplastic, a nozzle for the escape of the plastic, a deflection part and a winder,
characterized in that
the device comprises an actuator for inline affecting the quality of the film and a data processing and evaluation unit, wherein the data processing and evaluation unit has a programming, wherein the programming is performed for carrying out a method according to claim 1.

43. Device according to claim 42, characterized in that the device comprises a property measuring system for inline detecting an optical property of the film web.

44. Device according to claim 42, characterized in that the device is a measured variable measuring system for determining a measured value of the production process, in particular a process variable.

45. Device according to claim 42, characterized in that the device comprises a measured variable measuring system for determining a setting variable of the production process.

46. Device according to claim 42, characterized in that the device comprises an actuator for inline affecting the quality of the film having segmented control zones.

47. Device according to claim 42, characterized in that the device for producing a film web, is performed in particular in the form of a blown film or a cast film.
